(19) United States
(12) Patent Application Publication
(10) Pub. No.: US 2010/0306199 A1
(43) Pub. Date: Dec. 2, 2010

(54) USER-DEFINED HIERARCHICAL CATEGORIZATION SYSTEM AND METHOD FOR GENERATING OPERATIONAL METRICS

(75) Inventors: Todd Andrea, Ottawa (CA); Scott Helsby, Ottawa (CA)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Agnovi Corporation, Ottawa (CA)

(21) Appl. No.: 12/791,578

(22) Filed: Jun. 1, 2010

Related U.S. Application Data
(60) Provisional application No. 61/182,517, filed on May 29, 2009.

(51) Int. Cl. G06F 17/30

(52) U.S. Cl. 707/740; 707/E17.091

(57) ABSTRACT

The present invention provides a method, system and apparatus for categorizing information in a user-defined hierarchical category structure. Association of the information with a category additionally results in categorization of the information in all superior parental categories that are linked to the category. The present invention is also capable of generating metrics reports using the categorized information.

### FIELD OF THE INVENTION

The present invention pertains to a user-defined hierarchical categorization system, methods for storing user-defined hierarchical categories within a relational database, and methods for producing operational metrics based upon the categories.

### BACKGROUND

Hierarchical categorization systems are widely used by businesses and organizations to maintain, access, and analyze information. Typical categorization systems allow users to organize information according to a particular pre-defined hierarchical structure. However, due to the limitations of this pre-defined hierarchical structure, these systems are not well suited for categorizing information that does not satisfy the criteria for a specific pre-defined category or sub-category. Typically these systems include a “miscellaneous” or an “other” category for classifying such information.

Unfortunately, if the pre-defined hierarchical structure is not properly chosen, the amount of information stored in the miscellaneous category may eventually negate the usefulness of the categorization system.

As a result, defining the hierarchy or categorization structure requires considerable knowledge in advance of the information to be categorized. Unfortunately, depending upon the nature of the information to be categorized, there may be insufficient information available at the start of a project or case to properly define the categorization structure. As such, the categorization structure often requires additional successive modifications as more information becomes available. Implementing such modifications can be highly labour intensive, and typically cannot be accomplished by the end users.

For example, the efficient categorization of information pertaining to criminal or healthcare-related investigations requires a large number of categories and sub-categories, which are frequently subject to change, given the nature of these types of investigations.

Hierarchical categorization systems are also used to generate operational metrics based on the categorized information. Operational metrics permit organizations to efficiently analyze the categorized information based on a wide variety of parameters. For example, where the categorized information pertains to criminal or healthcare-related investigations, the operational metrics can help determine the efficiency and/or effectiveness of the investigative operations.

The usefulness of the operational metrics is dependent upon the categorization structure. As such, categorization systems with highly optimized categorization structures are ideal for generating operational metrics.

A need exists for a hierarchical categorization system for generating operational metrics with user-defined categories, which can be easily modified over time, by the end user, without intervention from another party, program re-compilation or program redeployment.

### SUMMARY OF THE INVENTION

The present invention is a user-defined hierarchical categorization system in which user-defined hierarchical categories are stored within an information database. Operational metrics are produced based upon the user-defined hierarchical categories. In addition, the present invention also includes an intuitive tree-based interface that permits a user to create, modify or delete one or more categories over time.

According to an aspect of the present invention, there is provided a method for categorizing information in a user-defined hierarchical category structure, said method comprising: receiving user-defined hierarchical category structure information; generating the user-defined hierarchical category structure as defined by the user-defined hierarchical category structure information, the structure comprising a plurality of categories; receiving uncategorized information for categorization in the user-defined hierarchical category structure; receiving relationship information associating the uncategorized information and at least one of the plurality of categories of the user-defined hierarchical category structure; categorizing the uncategorized information in the user-defined hierarchical category structure using the relationship information to generate categorized information; and storing the user-defined hierarchical category structure, the user-defined hierarchical category structure information, the categorized information and the relationship information in a database; wherein the step of categorizing the uncategorized information results in categorization of the uncategorized information in all superior parental categories that are linked to the at least one of the plurality of the categories.

According to a further aspect of the present invention, there is provided a system for categorizing information using a plurality of user-defined hierarchical categories comprising: data input means for receiving information about the user-defined hierarchical category structure; data processing means for generating the user-defined hierarchical category structure, as defined by the user-defined hierarchical category structure information; data input means for receiving relationship information associating uncategorized information and at least one of the plurality of categories of the user-defined hierarchical category structure; data processing means for categorizing the uncategorized information in the user-defined hierarchical category structure using the relationship information to generate categorized information; and database means for storing the user-defined hierarchical category structure, the user-defined hierarchical category structure information, the categorized information and the relationship information in a database; wherein during the categorizing of the uncategorized information, the uncategorized information is also categorized in all superior parental categories that are linked to the at least one of the plurality of the categories

According to another aspect of the present invention, there is provided a computer readable memory having recorded thereon statements and instructions for execution by a computer to carry out a method of the present invention.

### BRIEF DESCRIPTION OF THE FIGURES

FIG. 1 is a high-level architectural drawing illustrating the components of a system in accordance with one embodiment of the present invention.

FIG. 2 is a table for storing user-defined case categories and related fields in accordance with one embodiment of the present invention.

FIG. 3a is a flow diagram of a method for creating and storing a case category or sub-category record in a database table in accordance with one embodiment of the present invention.

FIGS. 3b, 3c, 3d and 3e illustrate components of a graphical user interface embodiment used to implement the method of FIG. 3a.

FIG. 4a illustrates a graphical user interface displaying a set of user-defined case categories/sub-categories pertaining to an example customs/border security organization.

FIG. 4b is a table that illustrates the contents of the database table that corresponds to the example set of case categories/sub-categories of FIG. 4a.

FIG. 5 is a table for storing user-defined result categories/sub-categories and related fields in accordance with one embodiment of the present invention.

FIG. 6a is a flow diagram of a method for creating and storing a result category/sub-category record in a database table in accordance with one embodiment of the present invention.

FIGS. 6b, 6c, 6d, 6e and 6f illustrate components of a graphical user interface embodiment used to implement the method of FIG. 6a.

FIG. 7a illustrates a graphical user interface displaying a set of user-defined result categories/sub-categories pertaining to an example customs/border security organization.

FIG. 7b is a table that illustrates the contents of the database table that corresponds to the example set of result categories/sub-categories of FIG. 7a.

FIG. 8a is a table for storing case to category associations and related fields in accordance with one embodiment of the present invention.

FIG. 8b is a table for storing case to result category associations and related fields in accordance with one embodiment of the present invention.

FIG. 8c is a table for storing cases and related fields used along with the tables shown in FIGS. 2 and 5 so as to provide identification numbers for populating the tables shown in FIGS. 8a and 8b.

FIG. 9a is a flow diagram of a method for creating and storing a case to category association record in a database in accordance with one embodiment of the present invention.

FIGS. 9b and 9c illustrate components of a graphical user interface embodiment used to implement the method of FIG. 9a.

FIG. 9d illustrates the contents of an example populated case to category association table, which corresponds to the example set of case categories/sub-categories shown in FIG. 9c.

FIG. 10a is a flow diagram of a method for creating and storing a case to result category association record in a database in accordance with one embodiment of the present invention.

FIGS. 10b and 10c illustrate components of a graphical user interface embodiment used to implement the method of FIG. 10a.

FIG. 10d illustrates the contents of an example populated case to result category association table, which corresponds to the example set of result categories/sub-categories shown in FIG. 10c.

FIG. 10e illustrates a graphical user interface that displays an example set of categories/sub-categories and results pertaining to a case from a customs/border security organization.

FIG. 11la is a flow diagram of a method for generating operational metrics according to one embodiment of the present invention.

FIGS. 11b and 11c illustrate components of a graphical user interface embodiment used to implement the method from FIG. 11a.

FIGS. 11d and 11e illustrate a sample operational metrics report from a customs/border security organization in accordance with one embodiment of the present invention.

FIG. 12a illustrates a graphical user interface displaying an example set of user-defined case categories/sub-categories and result categories pertaining to a financial institution.

FIGS. 12b and 12c illustrate components of a graphical user interface embodiment used to implement the methods of FIGS. 9a and 10a in the context of a case investigated by a financial institution using the set of user-defined case categories/sub-categories and result categories from FIG. 12a.

FIGS. 12d and 12e illustrate example operational metrics reports from a financial institution based on the set of user-defined case categories/sub-categories and result categories from FIG. 12a.

### DETAILED DESCRIPTION OF THE INVENTION

The present invention is now described with reference to the drawings. In the following description, for purposes of explanation, numerous specific details are set forth in order to provide a thorough understanding of the present invention. It may be evident, however that the present invention may be practiced without these specific details.

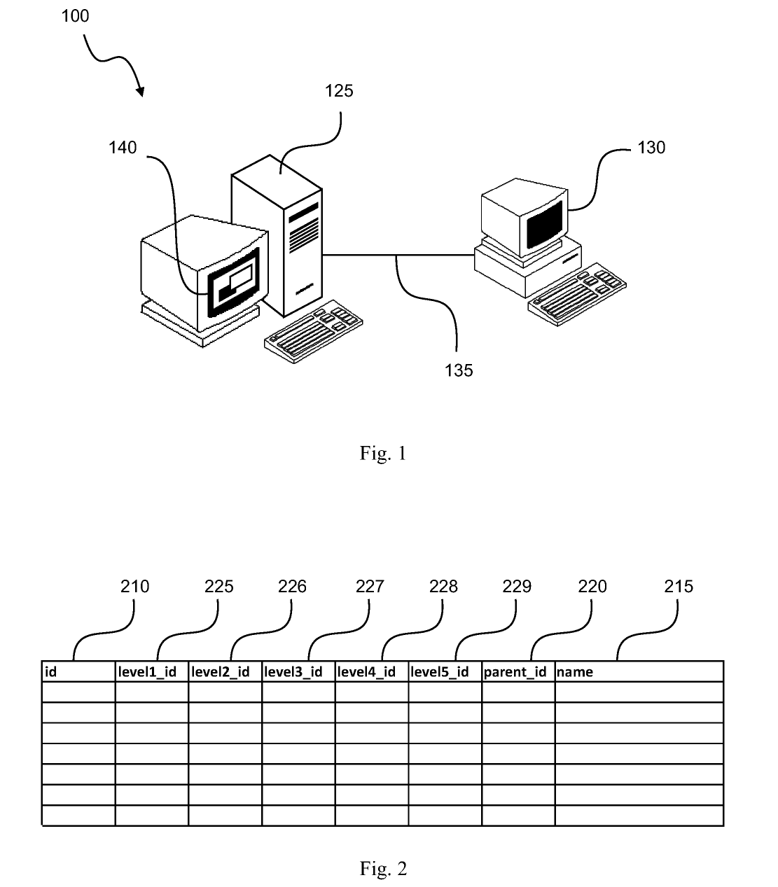

FIG. 1 illustrates the general architecture of a system in accordance with one embodiment of the present invention. System 100 includes a Server Computer 125 which stores an Application Server (not shown) and Application Server Logic Software (not shown) (collectively, Application Server and Application Server Logic Software are hereinafter referred to as “Application Software”). Application Server can be a J2EE or Java EE 5 application server, although a person of skill in the art will appreciate that any readily available application server including ASP.Net, CGI or PERL may be used. System 100 also includes a Database (also not shown) stored on either Server Computer 125 or on a computing device (not shown) networked to Server Computer 125. System 100 optionally includes at least one User-Computer 130 that is interfaced to Server Computer 125 by Network 135. Network 135 is a communication network based on an acceptable standard such as the TCP/IP open standard. Application Software is accessed through graphical user interface (“GUI 140”) installed on Server Computer 125 and User-Computer 130, if applicable. Optionally, GUI 140 is an Internet browser.

FIG. 2 illustrates an exemplary method of storing user-defined categories of a hierarchical category structure and related fields (the “Case Category Table”), within a Database in accordance with the present invention. Alternative methods of storing user-defined categories of a hierarchical category structure and related fields as would be known to the skilled worker, such as within a relational database, are also contemplated. Each category includes an Identification Field 210 for the category identification number, a Name Field 215, and a Parent Identification Field 220. In addition, each category also includes Level Fields 225, 226, 227, 228, and 229 for indicating the category's position or level in the hierarchy. For example, a root category will only have an entry in Level Field 225, which corresponds to the identification number stored in Identification Field 210. A sub-category will have entries in Level Fields 225 and 226, which correspond to the parent category's identification number and the sub-category's identification number respectively. A sub-sub-category will have entries in Level Fields 225, 226 and 227, and a sub-sub-sub-category will have entries in Level Fields 225, 226, 227 and 228. Although five level fields have been depicted in FIG. 2, the present invention supports any number of additional level fields to accommodate a greater number of nestled sub-categories.

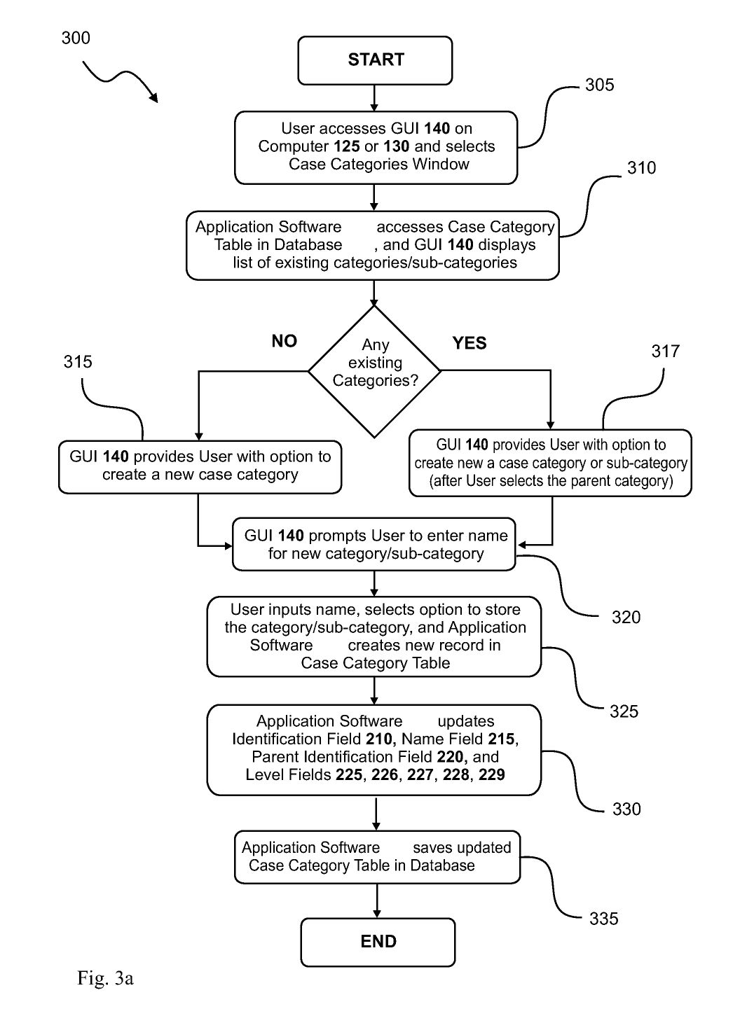

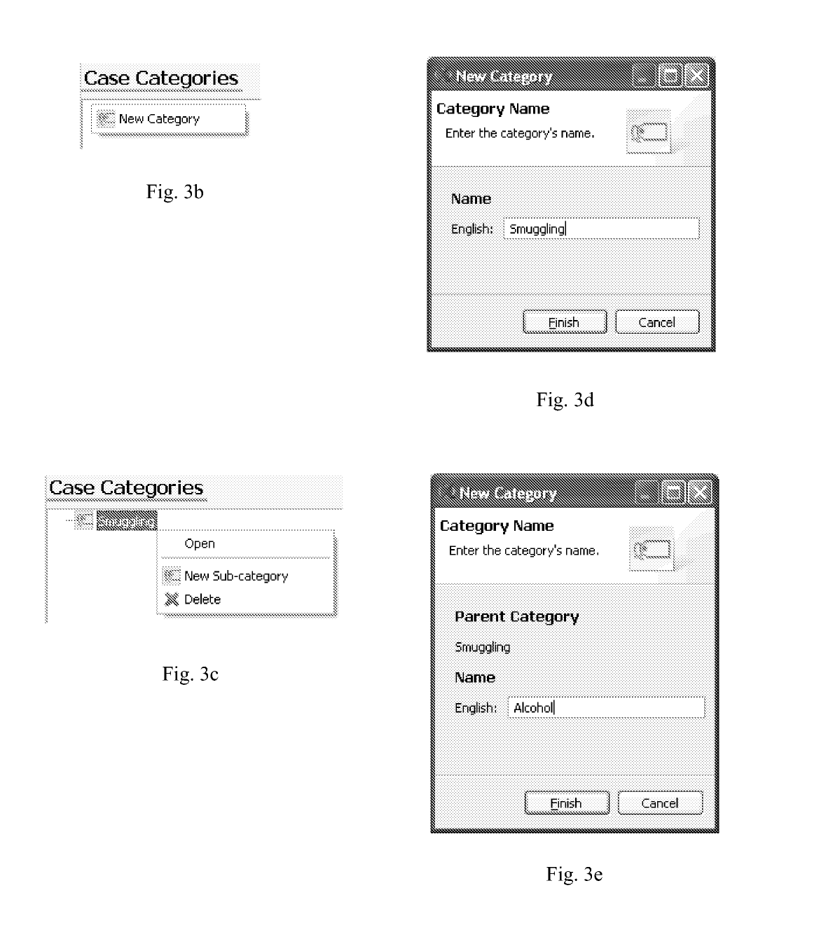

Referring to FIG. 3a, a flow diagram of a Method 300 for creating a user-defined hierarchical category structure is shown in accordance with one embodiment of the present invention. An authorized user (the “User”), such as a system administrator, accesses Application Software using GUI 140 on Server Computer 125 or User-Computer 130, and navigates to the Case Categories window at 305. Application Software accesses the Case Category Table from Database, and presents the User with a list of all previously created categories and sub-categories in the form of the user-defined hierarchical category structure, if any have been previously created, at 310. If no categories have previously been created, GUI 140 provides the User with the option to create a user-defined hierarchical category structure, starting with a new category at 315, as shown in the example of FIG. 3b. Alternatively, GUI 140 provides the User with the option to create a user-defined hierarchical category structure, starting with a new category or sub-category at 317. For the option to create a new sub-category, GUI 140 requires the User to select an existing category/sub-category as the parent for the new sub-category, as shown in the example of FIG. 3c. GUI 140 also provides the User with the option to modify aspects of the existing categories and sub-categories, such as the name of the category, or an effective date associated with the category.

If the User selects the “create new category” or the “create new sub-category” option, GUI 140 prompts the User to enter a name for the new category or sub-category at 320, as shown in FIGS. 3d and 3e. GUI 140 also indicates the name of the parent category, if applicable. After the User has input a name for the category/sub-category, and chooses to store the category/sub-category, Application Software causes a new record to be created in the Case Category Table in Database at 325. For this record, Application Software at 330, stores: a) a unique category identification number generated at this time by Database in Identification Field 210; b) the name entered by the user in Name Field 215; c) the identification number of the new category's parent category in Parent Identification Field 220, if applicable; d) the identification numbers of the new category's ancestor categories, if any in Level Fields 225, 226, 227, 228, and 229. Finally, Application Software saves the updated Case Category Table in Database at 335. This “master” user-defined hierarchical category structure is subsequently utilized to categorize information, such as cases.

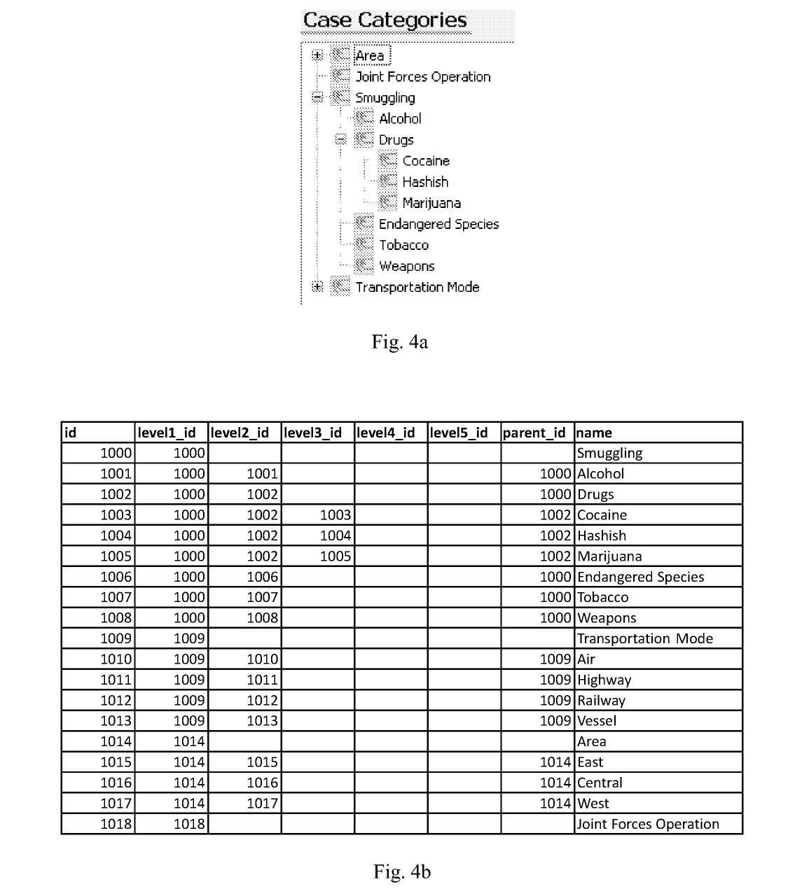

FIG. 4a illustrates an example of a user-defined hierarchical category structure for a customs/border security agency as displayed by GUI 140 and FIG. 4b illustrates the corresponding Case Category Table that includes some additional sub-categories not shown in FIG. 4a, which is stored in Database in accordance with the present invention. In this example, there are four root categories, namely “Area”, “Joint Forces Operation”, “Smuggling” and “Transportation Mode”. As such, the records corresponding to these categories in the Case Category Table do not have any entries under Parent Identification Field 220 and Level Fields 226, 227, 228, and 229. However, the record corresponding to the “Alcohol” sub-category, being a second level category has an entry under Parent Identification Field 220, and Level 1 and Level 2 Fields 225, 226.

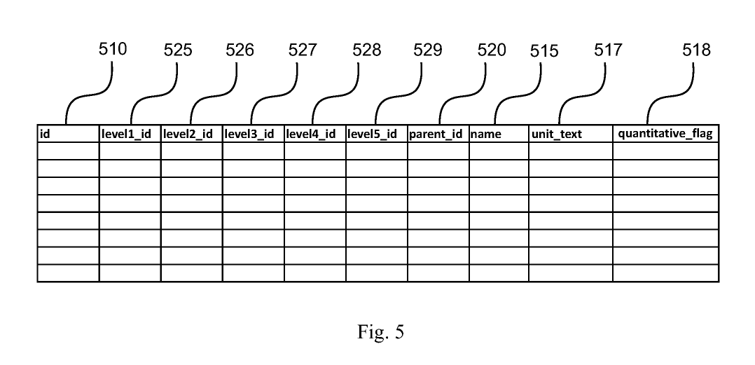

Another embodiment of the present invention provides a user-defined hierarchical category structure that can categorize quantitative information, such as quantitative information relating to cases. For example, FIG. 5 illustrates a table for storing user-defined case result categories of a hierarchical category structure (the “Result Category Table”), which itself is stored within Database in accordance with the present invention. Each entry in the Result Category Table includes an Identification Field 510, Name Field 515, Unit Text Field 517, Quantitative Flag Field 518, and a Parent Identification Field 520. In addition, each entry also includes Level Fields 525, 526, 527, 528, and 529, when appropriate, corresponding to the category's level in the hierarchy.

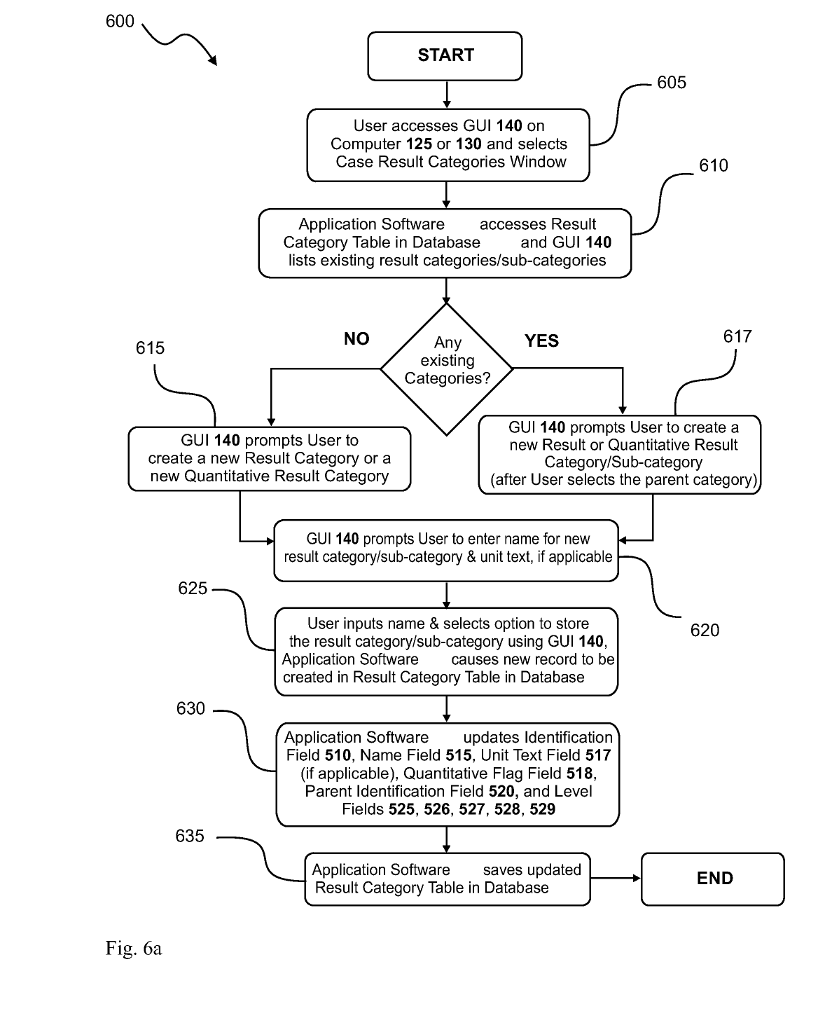

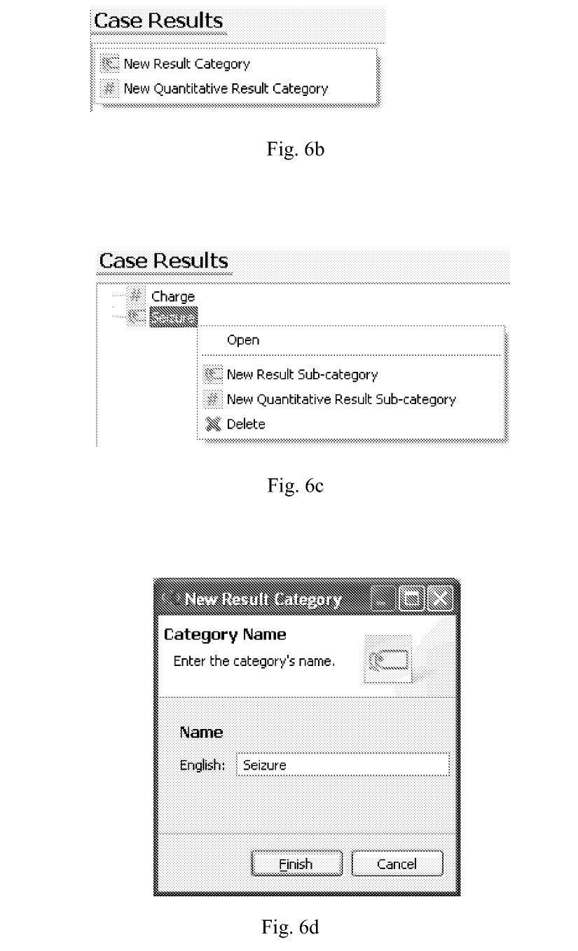

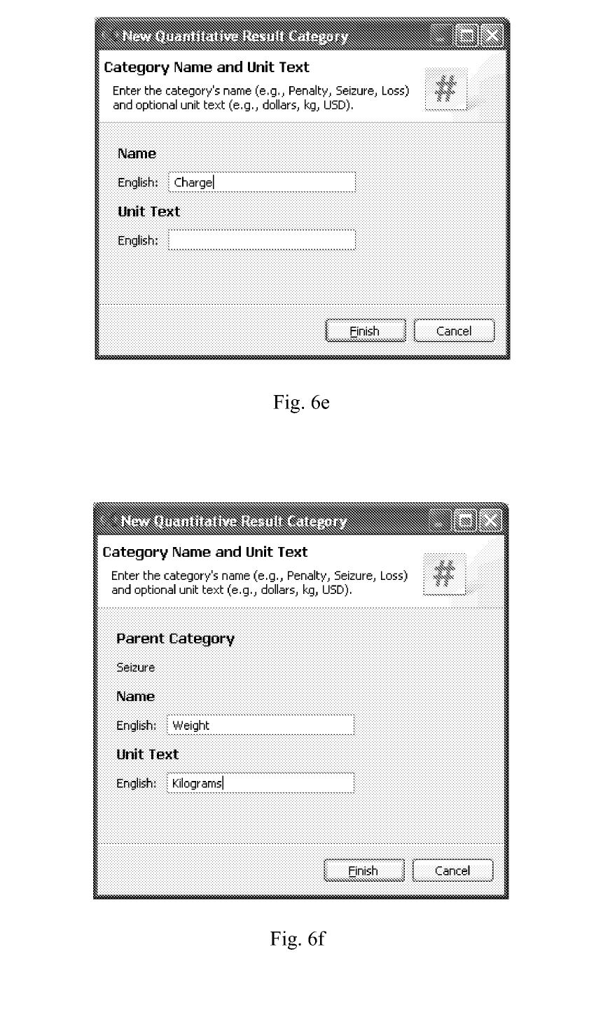

Referring to FIG. 6a, a flow diagram of a method 600 for creating an entry in the Result Category Table is shown in accordance with the present invention. The User, such as a system administrator, accesses Application Software using GUI 140 on Server Computer 125 or User-Computer 130, and navigates to the Case Result Categories window at 605. Application Software accesses the Result Category Table from Database, and GUI 140 presents the User with a list of all previously created result categories and sub-categories, in the form of the user-defined hierarchical category structure, if any have been previously created at 610. If no result categories have previously been created, GUI 140 presents the User with the options to create a user-defined hierarchical category structure, starting with a “New Result Category” or a “New Quantitative Result Category” at 615, as shown in FIG. 6b. If result categories in the form of a pre-existing user-defined hierarchical category structure, have previously been created, GUI 140 presents the User with the options to create a “New Result Category”, “New Result Sub-category”, “New Quantitative Result Category” or “New Quantitative Result Sub-category” at 617. For the options to create a new sub-category, GUI 140 requires the User to select an existing category/sub-category as the parent for the new sub-category, as shown in FIG. 6c. Optionally, GUI 140 also provides the User with the option to modify aspects of the existing result categories/sub-categories, such as the name of the category, or an effective date associated with the category.

If the User selects the option to create a “New Result Category”, “New Result Sub-category”, “New Quantitative Result Category” or “New Quantitative Result Sub-category”, GUI 140 prompts the User to enter a name for the new result category/sub-category or the new quantitative result category/sub-category at 620, as shown in FIGS. 6d and 6e respectively. In addition, GUI 140 also provides the User with an option to enter a unit text to be associated with a new quantitative result category/sub-category as shown in FIGS. 6e and 6f respectively.

After the User has input a name for the new result category/sub-category, and the corresponding unit text, if applicable, and chooses to store the result category/sub-category, Application Software causes a new record to be created in the Result Category Table in Database 120 at 625. For each category, the Application Software at 630 stores in the record: a) a unique identification number generated at this time by Database in Identification Field 510; b) the name entered by the user in Name Field 515; c) if applicable, the unit text entered by the user in Unit Text Field 517; d) whether or not the category is a quantitative category in Quantitative Flag Field 518; e) the identification number of the new category's parent category in Parent Identification Field 520, if applicable; f) the identification numbers of the new category's ancestor categories, in Level Fields 525, 526, 527, 528, and 529. Finally, Application Software saves the updated Result Category Table in Database 120 at 635. This “master” quantitative result user-defined hierarchical category structure is subsequently utilized to categorize information, such as cases.

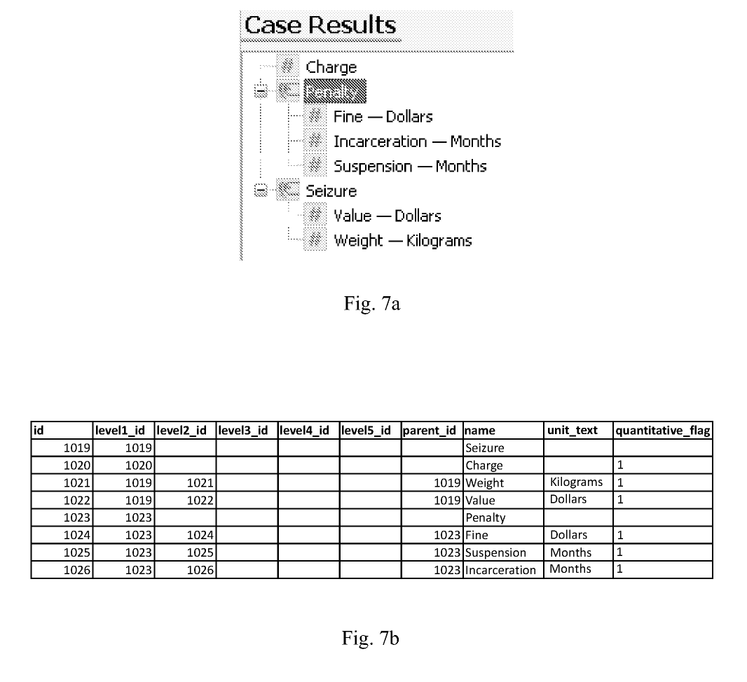

FIG. 7a illustrates an example of a user-defined hierarchical category structure for a customs/border security agency as displayed by GUI 140 and FIG. 7b illustrates the corresponding Result Category Table, which is stored in Database in accordance with the present invention. In this example, there are three root result categories, namely “Charge”, “Penalty” and “Seizure”. There are also three result sub-categories under “Penalty”, namely “Fine”, “Incarceration” and “Suspension”, and two result sub-categories under “Seizure”, namely “Value” and “Weight”. In this example, all of the result categories/sub-categories except “Penalty” and “Seizure” are quantitative.

Once the User has created a set of case and result hierarchical category structures comprising categories/sub-categories, the User may now establish associations between information, such as cases, and associated categories. Although it is also contemplated that only one hierarchical category structure be created that comprises both case and result categories. According to one embodiment of the present invention, this information is stored within two separate tables in Database, however, additional means to associate information with categories of the user-defined hierarchical category structures, as would be known to the skilled worker, are also contemplated.

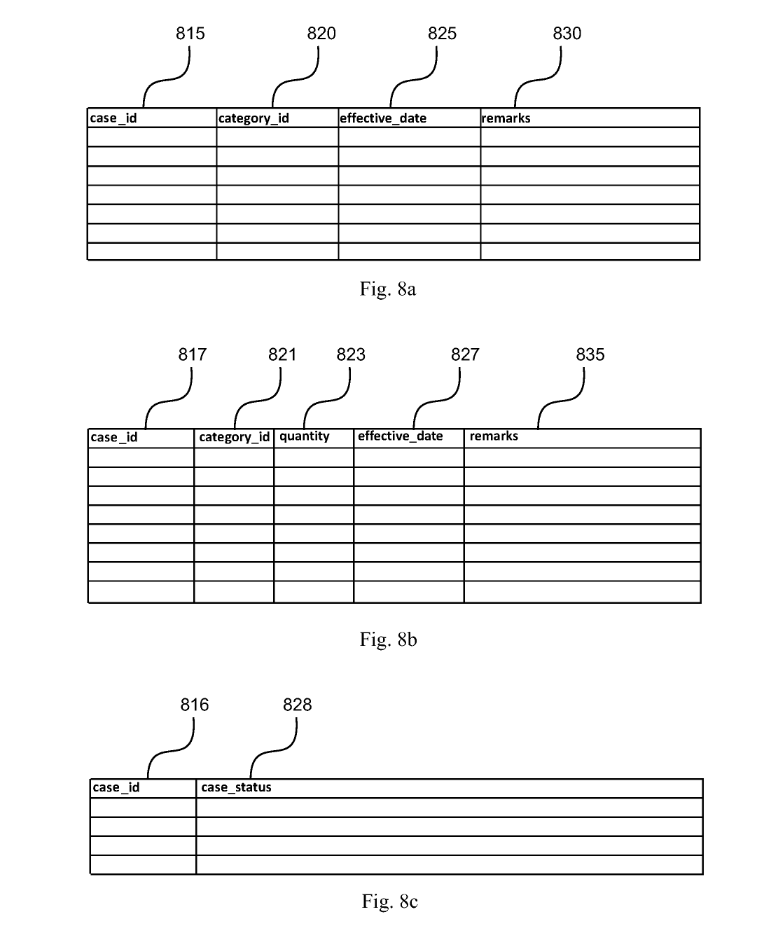

FIG. 8a illustrates a Case to Category Association Table (the “CCA Table”), which is stored within Database. Each record in the CCA Table includes Case-ID Field 815 for the unique ID that is assigned to uncategorized information e.g. a case, a Category-ID Field 820 corresponding to the category/sub-category ID of the category that has been associated with the uncategorized information, optionally an Effective Date Field 825 and a Remarks Field 830.

FIG. 8b illustrates a Case to Result Category Association Table (the “CRCA Table”), which is stored within Database. Each record in the CRCA Table includes Case-ID Field 817 that is assigned to uncategorized information e.g. a case, Category-ID Field 821 corresponding to the category/sub-category ID of the category that has been associated with the uncategorized information, Quantity Field 823, optionally an Effective Date Field 827 and a Remarks Field 835.

FIG. 8c illustrates a Case Table, which is stored in Database. Each record in the Case Table includes Case-ID Field 816 and Status Field 828. Optionally, the Case Table includes extra fields for storing additional information related to the case, such as status information pertaining to the case (open, pending or closed).

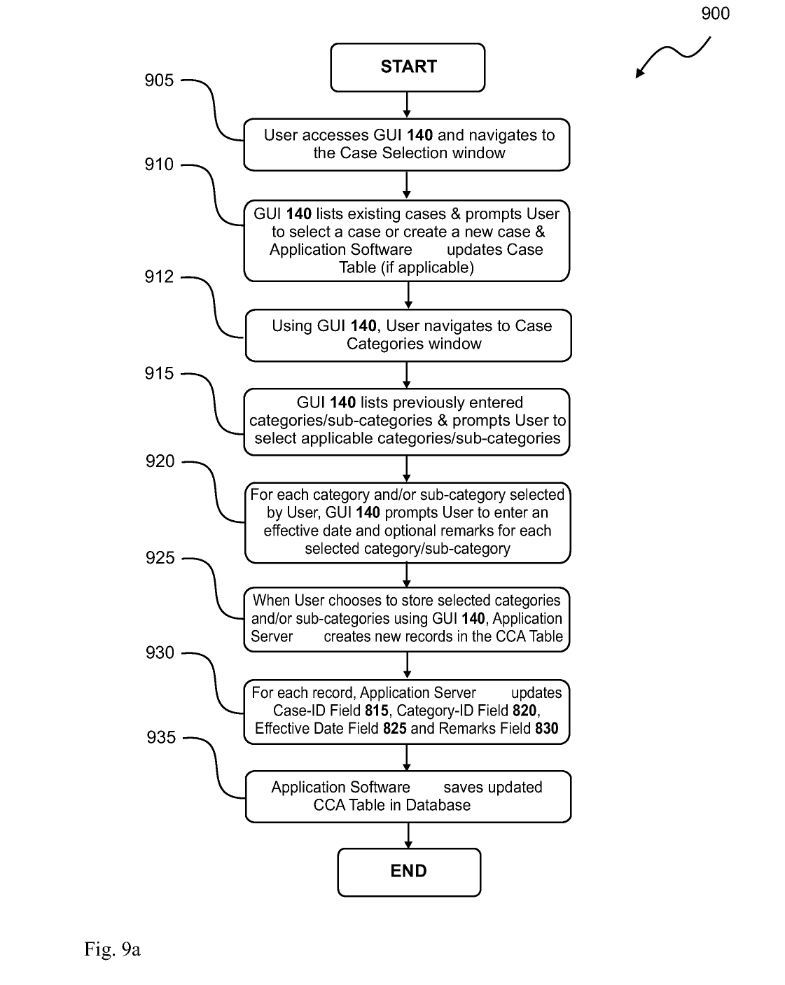

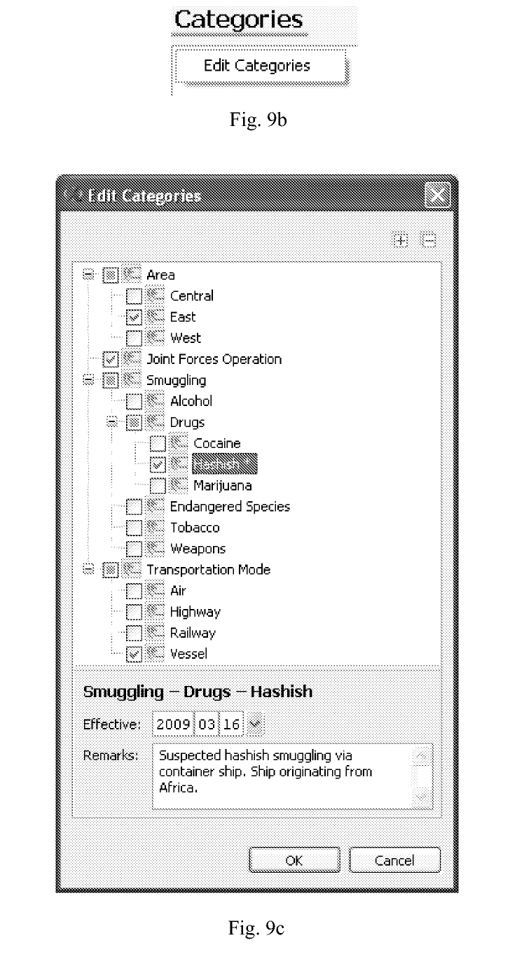

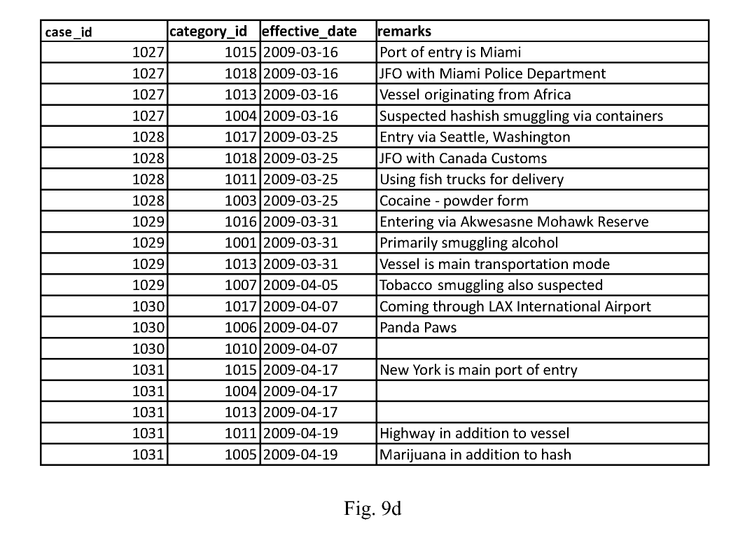

Referring to FIG. 9a, a flow diagram of a Method 900 for entering, categorizing and storing uncategorized information, such as an uncategorized case, and case categorization information in Database is shown in accordance with one embodiment of the present invention. The User accesses Application Software using GUI 140 on Server Computer 125 or User-Computer 130, and navigates to the Case Selection window (not shown), at 905. GUI 140 displays a list of existing cases from the Case Table, if any, and prompts the User to select an existing case or create a new uncategorized case to which the categorization information will pertain, at 910. If the user selects an existing case, Application Software extracts the corresponding record, including its identification number from Case-ID Field 816, from the Case Table. Alternatively, if a new uncategorized case is entered, application Software creates a new record in the Case Table, and a unique identification number is generated and stored in Case-ID Field 816 in the new record. In addition, GUI 140 also permits the User to update status information pertaining to the case (open, pending or closed), which is stored in the new or extracted record.

When a case has been selected, the User then navigates to the Edit Categories window at 912 using the GUI 140, as shown in FIG. 9b. GUI 140 then presents the User with the previously created user-defined hierarchical category structure, which includes a list of the available categories/sub-categories. The GUI 140 prompts the User to categorize the selected case by selecting and linking the selected case with the appropriate categories and/or sub-categories of the hierarchical category structure which are associated to the case at 915, as shown in FIG. 9c.

According to another embodiment, categorized information, such as a case that has been previously linked to a category of a user-defined hierarchical category structure, can be further categorized according to the present invention. For example, recent events may cause a case to qualify for categorization in additional categories. In this embodiment, the user selects a case that has been previously categorized, and the GUI 140 presents the user with the previously created user-defined hierarchical category structure. The categories of the category structure that have been already associated to the case are already selected, and the user further categorizes the case by linking the case with additional associated categories and/or sub-categories of the hierarchical category structure, as illustrated in FIG. 9c. Additionally, categories that have been previously associated with a case can be removed from a case.

When a user categorizes a case by selecting and associating it with a category/sub-category of the user-defined hierarchical category structure, all of the ancestral categories, such as the superior parental categories, of the selected category/sub-category are also selected and associated with the case. For example, when the sub-category “Hashish” is selected to categorize a case as shown in FIG. 9c, the superior parental categories “Drugs” and “Smuggling” are also automatically selected and associated with the case. The user is not required to manually select and link each of the selected category's parental categories with the case. Also, as can be seen from this example, a selected case can be linked with more than one category, up to as many categories as required.

For each category and/or sub-category selected by the User, GUI 140 prompts the User to enter an effective date and optionally, any remarks associated with the selected category/sub-category at 920.

When the User chooses to store associations between a case and selected categories and/or sub-categories, Application Server creates new records in the CCA Table at 925. For each record, Application Server at 930 stores: a) the Case-ID Number of the selected case in Case-ID Field 815; b) the identification number corresponding to the selected category/sub-category in Category-ID Field 820; and c) the effective date and optional remarks entered by the User in Effective Date Field 825 and Remarks Field 830 respectively. Finally, Application Server saves the updated CCA Table in Database at 935. However, alternative means of storing relationship information between a case and selected categories as would be known to one of skill in the art are also contemplated.

According to one embodiment, the CCA table has information about the superior parental categories of the selected category, such as their category ID, typically in Level Fields for indicating the categories' position or level in the hierarchy. In this embodiment, a selected case is automatically linked with the superior parental categories of the selected category.

FIG. 9d illustrates an example CCA Table stored in Database in accordance with the present invention. In this example, which pertains to a customs/border security organization, there are five cases that are indicated by Case-ID Numbers 1027, 1028, 1029, 1030 and 1031, which are stored in Case-ID Field 815. For example, the case that corresponds to Case-ID Number 1027 has been categorized in four categories. Optional remarks have been entered for all but three of the records in the table. According to one embodiment, in the example illustrated in FIG. 9d, information pertaining to the superior parental categories of category ID numbers 1015, 1018, 1013 and 1004 are also automatically linked to Case-ID Number 1027 and incorporated into the CCA table.

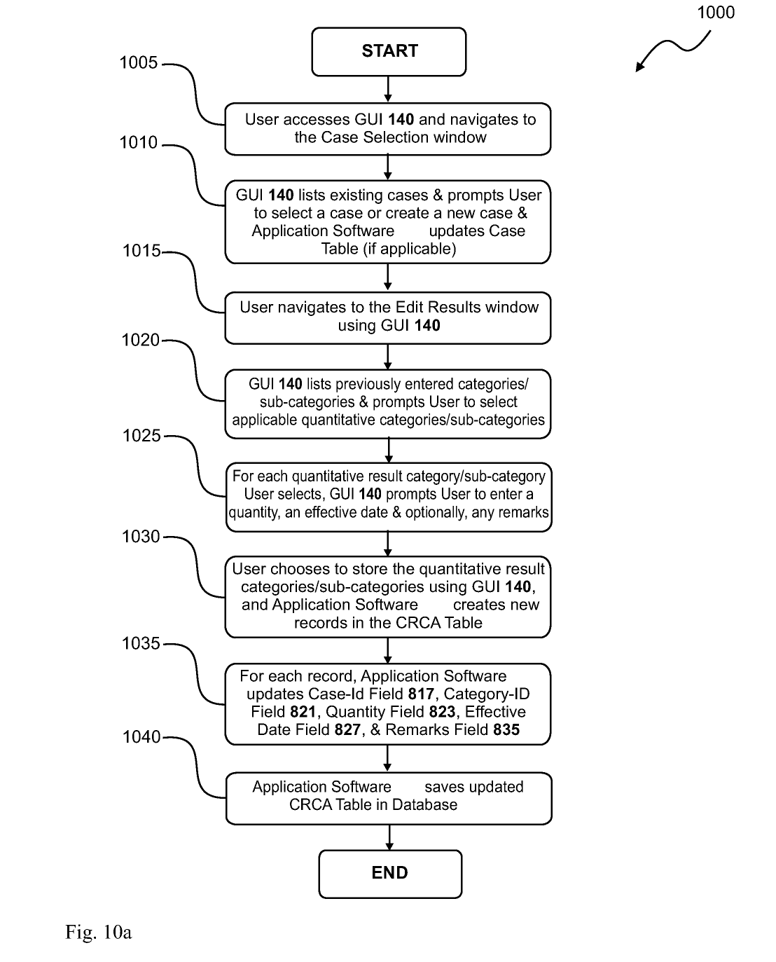

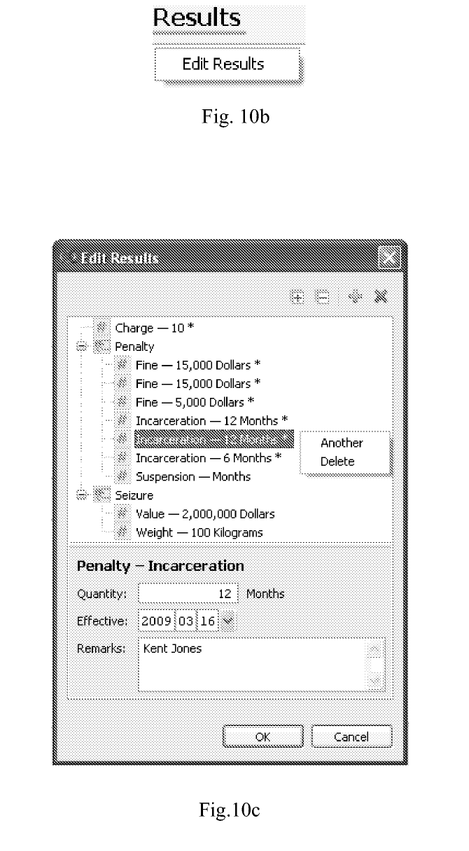

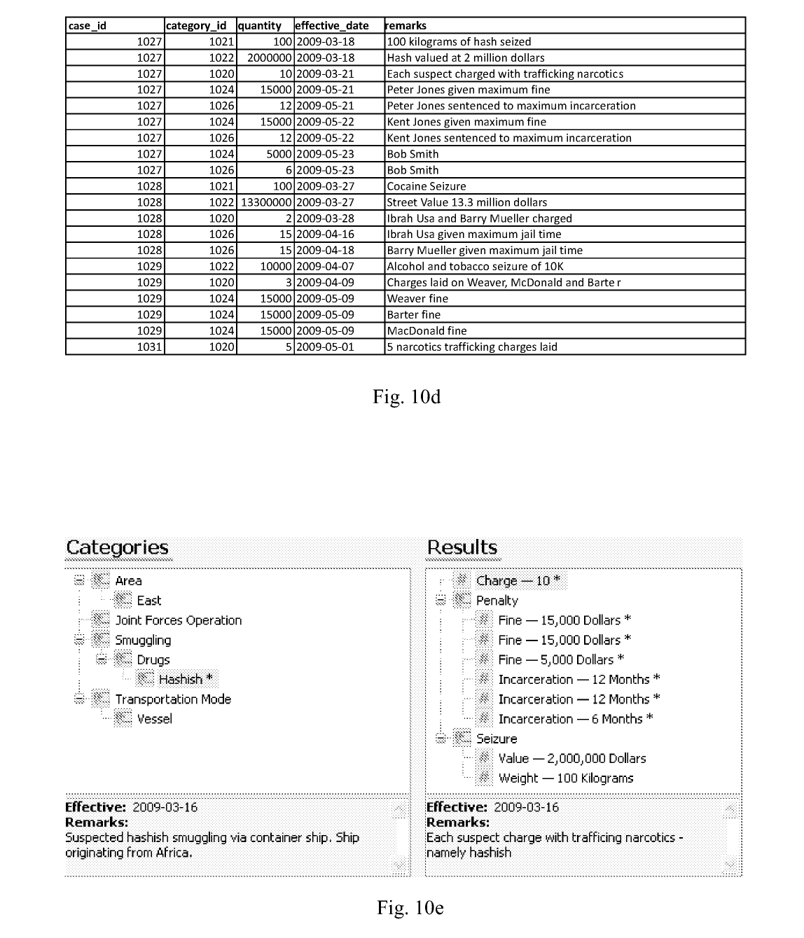

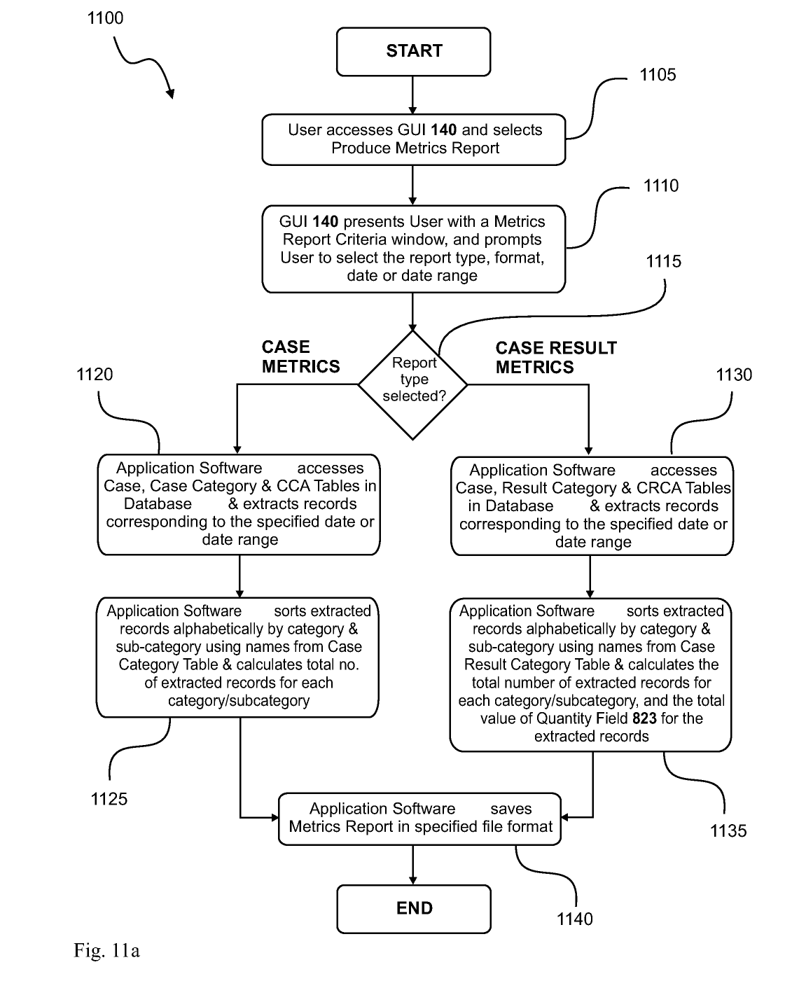

Referring to FIG. 10a, a flow diagram of a Method 1000 for entering, categorizing and storing uncategorized information, such as a case, in Database, is shown in accordance with one embodiment of the present invention. The User accesses Application Software using GUI 140 on Server Computer 125 or User-Computer 130, and navigates to the Case Selection window (not shown), at 1005. GUI 140 displays a list of existing cases from the Case Table, if any, and prompts the User to select an existing case or create a new uncategorized case to which the categorization information will pertain, at 1010. If the user selected an existing case, Application Software extracts the corresponding record, including its identification number from Case-ID Field 816, from the Case Table. Alternatively, if a new uncategorized case is entered, application Software creates a new record in the Case Table, and a unique identification number is also generated and stored in Case-ID Field 816 in the new record. In addition, GUI 140 also permits the User to update status information pertaining to the case (open, pending or closed), which is stored in the new or extracted record.

When a case has been selected, the User navigates to the Edit Results window using GUI 140 at 1015, as shown in FIG. 10b. GUI 140 then presents the User with the previously created user-defined hierarchical category structure having quantitative categories, which includes a list of the available result categories/sub-categories. The GUI 140 prompts the User to categorize the selected case by linking the selected case with the appropriate categories, sub-categories, quantitative result categories and/or quantitative result sub-categories of the hierarchical category structure which are associated with the case, as shown in FIG. 10c. As previously described, Application Software distinguishes between categories/sub-categories and quantitative result categories/sub-categories by checking Quantitative Flag Field 518.

According to another embodiment of the present invention, categorized information, such as a case that has been previously linked to a category of the previously created user-defined hierarchical category structure, can be further categorized. For example, recent developments can cause a categorized case to qualify for categorization in additional categories. In this embodiment, the user selects a case that has been previously categorized, and the GUI 140 presents the user with the previously created user-defined hierarchical category structure having quantitative categories. The categories of the category structure that have been already associated to the case are still selected, and the user further categorizes the case by linking the case with additional categories, sub-categories, quantitative result categories and/or quantitative result sub-categories of the hierarchical category structure, as illustrated in FIG. 10c.

When a user categorizes a case by selecting and associating it with a category/sub-category of the user-defined hierarchical category structure, all of the ancestral categories of the selected category/sub-category, such as superior parental categories, are also selected and associated with the case. For example, when the quantitative result sub-category “Incarceration—12 months” is selected and linked to a case as shown in FIG. 10c, the parental category “Penalty” is also automatically selected and associated with the case. The user is not required to manually select and link the selected case with each of the parental categories associated with the selected category.

For each quantitative result category/sub-category selected and linked to a case by the User, GUI 140 prompts the User to enter a quantity, an effective date and optionally, any remarks associated with both the selected case and the selected quantitative result category/sub-category at 1025. When the User chooses to store the case to result category associations, Application Software creates new records in the CRCA Table, at 1030. For each record, Application Software at 1035 stores: a) the Case-ID Number pertaining to the selected case in Case-ID 817; b) the identification number corresponding to the selected quantitative result category/sub-category in Category-ID Field 821; c) the quantity in Quantity Field 823; and d) the effective date and optional remarks entered by the User in Effective Date Field 827 and Remarks Field 835 respectively. In addition the present invention allows the User to select multiple instances of the same quantitative result category/sub-category. For example, in the context of a customs/border security organization, this feature allows the User to enter multiple counts of the same charge or sentence. Finally, Application Server saves the updated CRCA Table in Database at 1040.

According to one embodiment, the CRCA table has information about the parental categories of the selected quantitative result category, such as their category ID, typically in Level Fields for indicating the categories' position or level in the hierarchy. In this embodiment, a selected case is additionally automatically linked with the parental categories of the selected category.

FIG. 10d illustrates an example CRCA Table stored in Database in accordance with the present invention. In this example, which pertains to a customs/border security organization, there are four cases indicated by Case-ID Numbers 1027, 1028, 1029 and 1031, which are stored in Case-ID Field 817. For example, the case that corresponds to Case-ID Number 1027 has been categorized in nine result categories with quantitative result information, and optional remarks have been entered for all records in the table. According to one embodiment, in the example illustrated in FIG. 10d, information pertaining to the superior parental categories of the selected category ID numbers 1021, 1022, 1020, 1024 and 1026 are automatically associated with Case-ID Number 1027 and are incorporated into the CRCA table.

After the User has finished entering case categorization or result information and categorizing the cases using Method 900 or Method 1000, the User may view the case categorization and result information using GUI 140 as shown in FIG. 10e.

According to one embodiment, when subsequent cases are being categorized, the need for modifying the previously created or “master” user-defined hierarchical category structure may arise. The GUI 140 allows the User to further modify the previously created user-defined hierarchical category structure by addition, deletion or editing of a category/sub-category. For example, if a sub-category was originally included in the previously created user-defined hierarchical category structure based upon its perceived future relevance, and is subsequently deemed irrelevant, it can be deleted from the category structure. Alternatively, a new category/sub-category can be created and integrated into the previously created category structure. Modification can be performed during the life of the previously created or “master” user-defined hierarchical category structure.

After case categorization or result information has been entered into System 100 using Method 900 or Method 1000, and the cases have been categorized, the case categorization and result information stored in System 100 may be used to generate operational metrics for analysis.

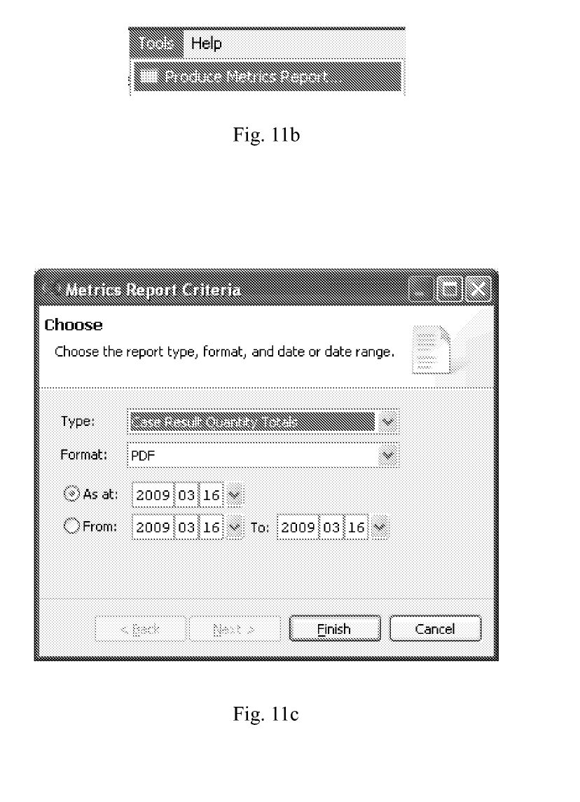

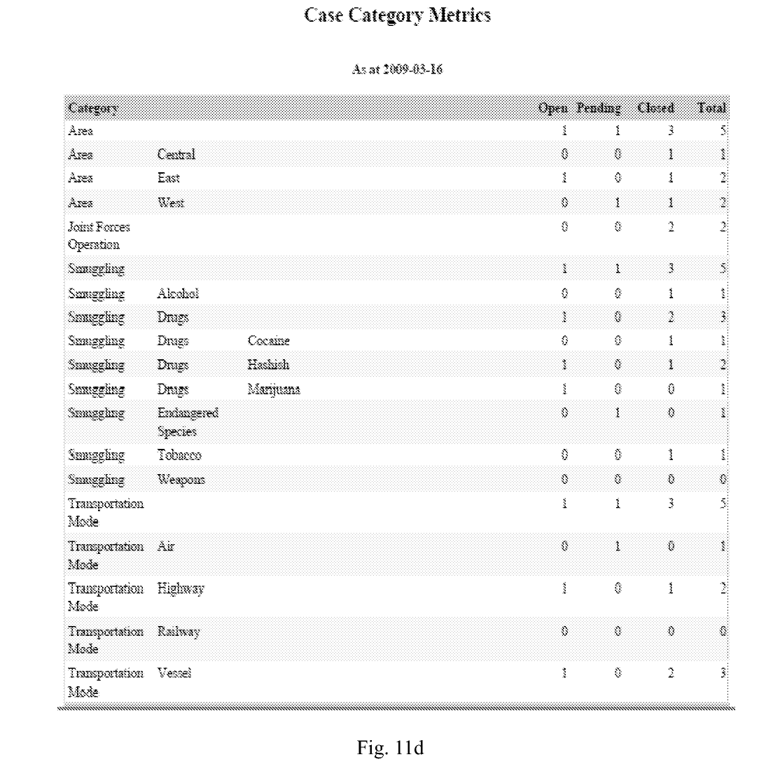

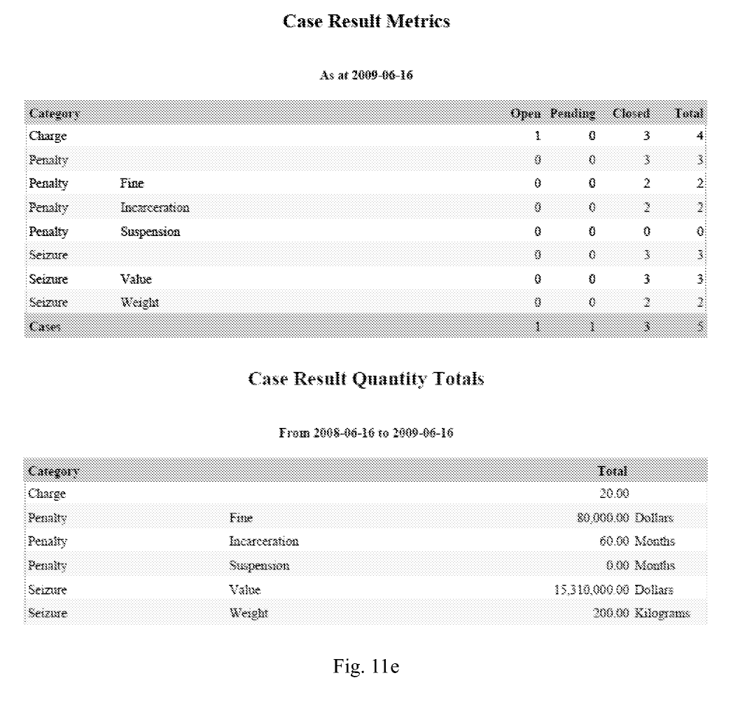

Referring to FIG. 11a, a flow diagram of a Method 1100 for generating operational metrics in accordance with an embodiment of the present invention is shown. The User accesses GUI 140 using Server Computer 125 or User-Computer 130. Using GUI 140, the User selects Produce Metrics Report under the Tools Menu at 1105, as shown in FIG. 11b. Next, GUI 140 presents the User with a Metrics Report Criteria window, and prompts the User to indicate the metrics criteria information, such as the type of report, report file format, and the date or date range for the metrics report, at 1110, as shown in FIG. 11c. Other criteria able to sort the categorized information can also serve as a basis for the metrics report, such as by indicating specific categories/sub-categories. If the User selects a “Case Category Metrics Report” and specifies a date range at 1115, Application Software accesses the Case, Case Category, and CCA Tables from Database. Application Software then extracts the records from the CCA Table, which correspond to the specified date or date range at 1120. Next, Application Software sorts the extracted records alphabetically by category and sub-category by referencing the category/sub-category names stored in the Case Category Table. In addition, Application Software also calculates the total number of extracted records that correspond to each category/sub-category stored in the Case Category Table, at 1125. In addition, when the present invention is applied to investigative cases, Application Software also calculates the status of these categorized cases, such as the total number of open, pending or closed cases that have been associated with each category/sub-category linked to the extracted records. Finally, Application Software saves the metrics report in the report file format selected by the User, at 1140. FIG. 11d illustrates an example Case Category Metrics Report, which pertains to a customs/border security organization.

If the User selects a “Case Result Metrics Report” and specifies a date range at 1115, Application Software accesses the Case Result Category, and CRCA Tables from Database, and extracts the records from the CRCA Table that correspond to the specified date or date range at 1130. Next, Application Software at 1135 sorts the extracted records alphabetically by category and sub-category by referencing the category/sub-category names stored the Result Category Table. Next, for each category/sub-category stored in the Result Category table, Application Software calculates the total number of extracted records. In addition, for each quantitative result category/sub-category Application Software calculates the sum of the quantities of the extracted records linked to the category/sub-category. When the present invention is applied to investigative cases, Application Software further calculates the status of these categorized cases, such as the total number of open, pending or closed cases that have been associated with each category/sub-category linked to the extracted records. Finally, Application Software saves the metrics report in the report file format selected by the User, at 1140.

FIG. 11e illustrates an example Case Result Metrics Report, which pertains to a customs/border security organization.

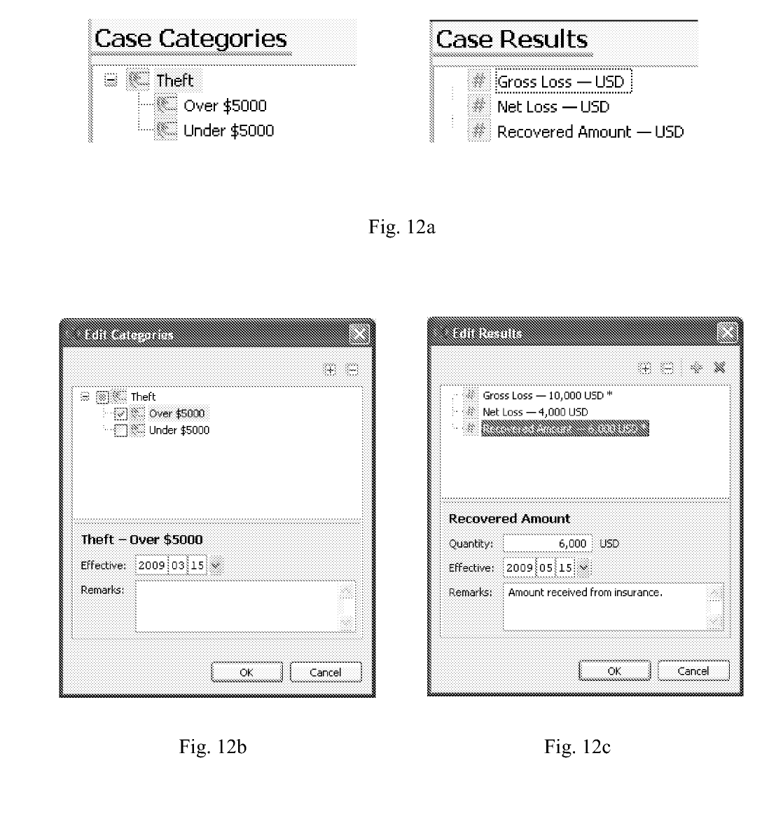

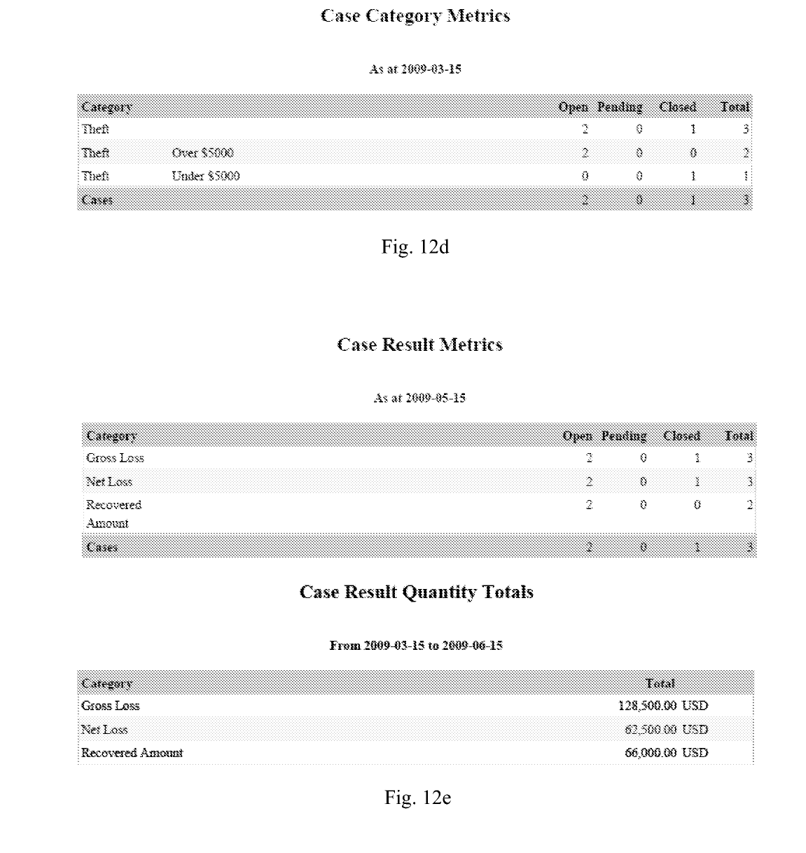

Although the present invention has been described in the context of customs or border security investigative cases and associated categories and results, the present invention is readily adaptable to a variety of applications where information requires categorization, and is typically subsequently analyzed by way of a metrics report For example, a financial institution, such as a bank, may have investigative information pertaining to theft. This information might be categorized under “Theft” into the sub-categories: “Under $5,000”, and “Over $5,000”. Based on this example, the result categories could include: “Gross Loss”, “Net Loss”, and “Recovered Amount”. FIG. 12a illustrates an example set of case categories/sub-categories and result categories pertaining to a financial institution displayed by GUI 140 following the completion of Methods 300 and 600. FIGS. 12b and 12c illustrate the corresponding “master” user-defined hierarchical category structures, as shown in the Edit Categories and Edit Results windows displayed by GUI 140 at steps 915 and 1020 from Methods 900 and 1000 respectively. FIGS. 12d and 12e illustrate the corresponding Case Category and Result Metrics Reports generated using Method 1100.

Unlike existing rigid hierarchical systems for categorizing information and generating operational metrics, the present invention enables the end-user to quickly and efficiently create, edit and delete categories. As these categories are not hard coded into the system, the present invention enables the end-user to readily amend the hierarchy without intervention from another party, program re-compilation or program redeployment.

Advantageously, when the User is categorizing information by selecting the associated category or categories at 915 and 1015, the User is also not required to manually select the ancestral categories, such as the parent categories, in addition to the appropriate sub-category. Once the end-user categorizes information by selecting a sub-category, the ancestor categories, such as the superior parental categories, are automatically selected by the system and linked to the information.

Although the description above contains many specific details, these should not be construed as limiting the scope of the embodiments but as merely providing illustrations of some of the presently preferred embodiments. Thus the scope of the embodiments should be determined by the appended claims and their legal equivalents, rather than by the examples given.

What is claimed:

1. A method for categorizing information in a user-defined hierarchical category structure, said method comprising:
a) receiving user-defined hierarchical category structure information;
b) generating the user-defined hierarchical category structure as defined by based upon the user-defined hierarchical category structure information, the structure comprising a plurality of categories;
c) receiving uncategorized information for categorization in the user-defined hierarchical category structure;
d) receiving relationship information linking the uncategorized information and at least one of the plurality of categories of the user-defined hierarchical category structure;
e) categorizing the uncategorized information in at least one of the plurality of categories of the user-defined hierarchical category structure using the relationship information to generate categorized information; and
storing the user-defined hierarchical category structure, the user-defined hierarchical category structure information, the categorized information and the relationship information in a database;
wherein the step of categorizing the uncategorized information results in categorization of the uncategorized information in superior parental categories that are linked to the at least one of the plurality of the categories.

2. The method of claim 1, further comprising the steps of:
g) receiving metric information pertaining to at least one metric; and
h) generating at least one report using the user-defined hierarchical category structure information, the categorized information and the metric information.

3. The method of claim 1, wherein the user-defined hierarchical category structure is capable of being modified through editing, adding or deleting categories.

4. The method of claim 3, wherein the modification of the user-defined hierarchical category structure occurs before, during and/or after categorization of the uncategorized information.

5. The method of claim 1, wherein the user-defined hierarchical category structure information comprises identification of the plurality of categories as a root category or a sub-category.

6. The method of claim 1, wherein the user-defined hierarchical category structure information comprises defining the ancestral relationship between the plurality of categories.

7. The method of claim 1, wherein the user-defined hierarchical category structure information comprises identification of the plurality of categories as a qualitative category or a quantitative category.

8. The method of claim 7, wherein the uncategorized information for categorization in the quantitative category comprises numerical information and/or unit information.

9. The method of claim 1, wherein the relationship information comprises identification of the at least one of the plurality of categories of the user-defined hierarchical category structure in which to categorize the uncategorized information.

10. The method of claim 1, wherein the database comprises separate relational database tables corresponding to the user-defined hierarchical category structure information, categorized information and relationship information.

11. The method of claim 1, wherein the categorized information is further categorized by associating previously categorized information with at least one additional category of the user-defined hierarchical category structure information.

12. The method of claim 1, wherein the uncategorized information pertains to an investigation.

13. The method of claim 2, wherein the metric information comprises identification of at least one of the plurality of categories, date information, report type information and/or report format information.

14. A system for categorizing information using a plurality of user-defined hierarchical categories comprising:
a) data input means for receiving information about the user-defined hierarchical category structure;
b) data processing means for generating the user-defined hierarchical category structure which comprises a plurality of categories, as defined by the user-defined hierarchical category structure information;
c) data input means for receiving relationship information associating uncategorized information and at least one of the plurality of categories of the user-defined hierarchical category structure;
d) data processing means for categorizing the uncategorized information in the user-defined hierarchical category structure using the relationship information to generate categorized information; and
e) database means for storing the user-defined hierarchical category structure, the user-defined hierarchical category structure information, the categorized information and the relationship information in a database;
wherein during the categorizing of the uncategorized information, the uncategorized information is categorized in all superior parental categories that are linked to the at least one of the plurality of the categories.

15. The system of claim 14, further comprising:
f) data input means for receiving metric information pertaining to at least one metric; and
g) data processing means for generating at least one report using the user-defined hierarchical category structure information, the categorized information and the information pertaining to at least one metric.

16. The system of claim 14, further comprising a graphical user interface for accessing the system.

17. A computer readable memory having recorded thereon statements and instructions for execution by a computer to carry out the method according to claim 1.
